(19) United States
(12) Patent Application Publication
(10) Pub. No.: US 2008/0228920 A1
(43) Pub. Date: Sep. 18, 2008

(54) SYSTEM AND METHOD FOR RESOURCE AGGREGATION AND DISTRIBUTION

(76) Inventors: Steven K. Souders, Los Altos, CA (US); Tenni Theurer, San Jose, CA (US)

Correspondence Address: YAHOO! INC.;C/O DREIER LLP, 499 PARK AVENUE, NEW YORK, NY, 10022, US

(21) Appl. No.: 11/687,307

(22) Filed: Mar. 16, 2007

(51) Int. Cl. G06F 15/173

(52) U.S. Cl. 709/226

(57) ABSTRACT

The present invention relates to systems and methods for the aggregation and distribution of resources. The method according to one embodiment receiving a request from a client by a content delivery network (“CDN”) for a resource that comprises a plurality of resources and concatenating the plurality resources at the content delivery network to generate a concatenated resource. The concatenated resource is propagated to the client through the content delivery network.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to loading content items. More specifically, the invention relates to concatenating a plurality of resources into a single concatenated resource for propagation to clients connected to a content delivery network.

### BACKGROUND OF THE INVENTION

Developers of web sites and web applications are increasingly making use of resources such as JavaScript (to provide interactivity) and Cascading Style Sheets (for highly customized layouts) to produce functionally rich and visually appealing web pages. JavaScript and Cascading Style Sheets may be programmed inline within an HTML document, e.g., the program code is included in a given instance of the served HTML document. Developers, however, typically prefer to place the program code into one or more files that are external to the HTML document and whereby the HTML document links to or references the external file. This technique has a number of advantages, including ease of code maintenance, smaller HTML document page weight and better use of the browser cache.

One drawback of putting such program code into files that are external to the HTML document is that this often results in slower response time due to the fact that each external file requires an HTTP request. During development, program code is organized into logical modules as separate files. Requiring programmers to place program code into a single external file (thereby resulting in a single additional HTTP request), however, is burdensome on the development process. Furthermore, every time there is a change to an individual file, the larger file must be recombined and pushed back out to clients.

Thus, there is a need in the art for systems, methods and computer program products that allow developers to maintain the logical organization of program code in separate files while achieving the advantages of combining resources into a single file as part of the final user experience.

### SUMMARY OF THE INVENTION

The present invention is directed towards methods, systems and computer readable media comprising program code for aggregating disparate resources for distribution to clients over a content delivery network. Embodiments of the present invention provide a resource aggregator that executes at one or more origin servers in a content delivery network (“CDN”). The CDN is operative to aggregate a plurality of resources into a single concatenated resource for propagation to clients connected to the CDN, which may include propagation through the use of one or more edge severs in the CDN in communication with the clients and one or more origin servers.

According to one embodiment, the invention is directed towards a method for the aggregation and distribution of resources. The method according to one embodiment comprises receiving a request from a client by a content delivery network for a resource that comprises a plurality of resources. The plurality of resources at the content delivery network are concatenated to generate a concatenated resource. The concatenated resource is propagated to the client through the content delivery network. Receiving the request may comprise receiving a request for a plurality of JavaScript files. Similarly, receiving the request may comprise receiving a request for a plurality of Cascading Style Sheet files. The request may also be a request for a plurality of other resources or content known to those of skill in the art including, but not limited to, audio, video, etc.

Receiving the request may comprise receiving the request by an edge server in the content delivery network. The content delivery network comprising one or more edge servers located through a network such as the Internet. The given edge server that receives the request may perform a check to determine if a cached copy of the concatenated resource is available to the edge server. Where a cached copy of the concatenated resources is available to the edge server (e.g., at a data store in communication with the edge sever) the edge server transmits or otherwise propagates the cached copy of the concatenated resource to the client. The method may further comprise transmitting the request for the resource from the edge server to an origin server if the cached copy of the concatenated resource is not available at the edge server and receiving the request at the origin server for concatenation of the plurality resources.

According to one embodiment, propagating comprises transmitting the concatenated resource from an origin sever in the content delivery network to the requesting client. Alternatively, or in conjunction with the foregoing, propagating may comprise transmitting the concatenated resource from an origin server to an edge server from which the origin server receives the request. Accordingly, the concatenated resource may be transmitted from the edge server to the requesting client. Furthermore, the edge sever may cache the concatenated resource to provide to clients in response to one or more future requests, which may comprise caching the concatenated resource at one or more other edge servers in the CDN.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a block diagram illustrating a system for resource aggregation and distribution according to one embodiment of the present invention;

FIG. 2 presents a block diagram illustrating a resource aggregator according to one embodiment of the present invention;

FIG. 3 presents a flow diagram illustrating a method for resource aggregation and distribution according to one embodiment of the present invention;

FIG. 4 presents a flow diagram illustrating an alternative method for resource aggregation according to one embodiment of the present invention; and

FIG. 5 presents a flow diagram illustrating a method for resource aggregation according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

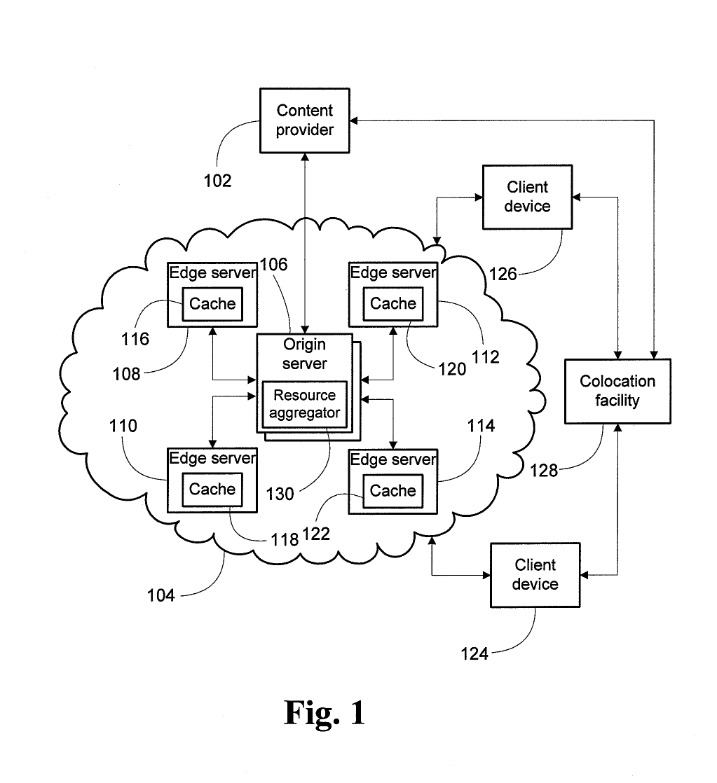

FIG. 1 presents a block diagram depicting a system for resource aggregation according to one embodiment of the present invention. According to the embodiment illustrated in FIG. 1, one or more client devices 124 and 126 are communicatively coupled to a content delivery network 104, which may include a connection to one or more local and wide area networks, such as the Internet. According to one embodiment of the invention, a given client device 124 and 126 is a general-purpose personal computer comprising a processor, transient and persistent storage devices, input/output subsystem and bus to provide a communications path between components comprising the general-purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

A given client device 124 and 126 may be in communication with a colocation facility 128 that hosts one or more content items. A given client device 124 and 126 may be in communication with the colocation facility 128 over the same network on which the content delivery network 104 resides. A client device 124 and 126 may also be in communication with the colocation facility 128 over a disparate network. The colocation facility 128 may maintain one or more web severs, a given web server hosting one or more web pages. The colocation facility 128 may also comprise a repository for the storage and transmission of one or more content items in response to a request from a client device 124 and 126. For example, the colocation facility 128 may comprise a web site that includes a web server (e.g., Apache™, Internet Information Server™, etc.) and a data store, which according to one embodiment is a database that maintains web pages in an organized and structured manner. The colocation facility 128 may further maintain program code that, when executed by the colocation facility 128, is operative to dynamically generate one or more content items.

A given client device 124 and 126 in communication with the colocation facility 128 requests a content item that a content provider 102 maintains at the colocation facility 128. Typically, the content provider 102 maintains dynamic information at the colocation facility 128 for delivery to a client device 124 and 126. For example, where the content provider 102 is using the colocation facility 128 to host one or more web pages, the colocation facility 128 may provide the HTML or page markup to a given client 124 and 126, which the colocation facility 128 may generate dynamically on the basis of program or scripting code that the content provider 102 maintains at the colocation facility 128, e.g., Active Sever Page or Java Server Page code.

A resultant page that the colocation facility 128 provides to a client 124 and 126 may have links or references to one or more items of static resources for inclusion in the page and rendering by the client 124 and 126. Exemplary resources that a content item may comprise include, but are not limited to, JavaScript files, Cascading Style Sheets, images, video and audio. The content delivery network 104 is operative to host these resources. Links or references in a given content item (such as HTML or other page markup) instruct the client 124 and 126 to retrieve these resources from the content delivery network 104.

According to one embodiment, a content delivery network 104 may be a specialized subset of nodes contained in a larger network, such as the Internet. The content delivery network 104 comprises one or more origin servers 106 and one or more edge servers 108, 110, 112 and 114. Resources at the origin server 106 are propagated to the edge severs 108, 110, 112 and 114 in the content delivery network 104, with a given edge server 108, 110, 112 and 114 operating a cache 116, 118, 120 and 122, respectively, to maintain a copy of the plurality resources. A given client 124 and 126 connects to an optimal edge server 108, 110, 112 and 114 to retrieve or otherwise receive resources from the content delivery network 104. A given client 124 and 126, however, may receive content required from the content delivery network 104 by connecting to any edge server 108, 110, 112 and 114.

According to one embodiment, a link or reference in a given content item for the retrieval of a plurality of resources takes the form of the URL illustrated in Table A:

TABLE A

```
<script type=”text/javascript”
  src=”http://us.js2.yimg.com/us.js.yimg.com/
  ira?file1.js&file2.js&file3.js>
</script>
```

The “script” tag instructs the client device that the lines of code following the tag comprise a script, which in the present example is JavaScript. Those of skill in the art recognize that other scripting languages that a given client 124 and 126 is operative to process may be used including, but not limited to, PHP, Ruby, Python, etc. The following lines of the script instruct the client device 124 and 126 as to the location of the source of the script. According to the present example, the code instructs the client device 124 and 126 to first interrogate an edge server on the content delivery network 104 located at us.js2.yimg.com for the resource, followed by interrogation of an origin server on the content delivery network 104 located at usjs.yimg.com for the resource. Finally, the client device is interrogating the content delivery network to retrieve the resource “ira?file1.js&file2.js&file3.js”. As is explained in greater detail herein, forming the request for the resource as a call to a function and providing a number of resources as parameters to the function eliminates the need to execute separate calls to retrieve each resource.

Continuing with the present example, the client device 124 and 126 processes the exemplary link or reference to the resource “ira?file1.js&file2.js&file3.js” by querying an edge server 108, 110, 112 and 114 of the content delivery network 104 for the resource. A given edge server 108, 110, 112 and 114 in communication with the client device 124 and 126 checks a local resource cache 116, 118, 120 and 122, respectively, to determine if a local copy of the resource “ira?file1.js&file2.js&file3.j” is available. Where the edge server 108, 110, 112 and 114 has access to a cached copy of the resource, the edge server 108, 110, 112 and 114 returns the resource to the client 124 and 126. Where the edge server 108, 110, 112 and 114 does not have a copy of the resource that the client is requesting in the cache 116, 118, 120 and 122, the edge server 108, 110, 112 and 114 passes the request to a given origin server 106 on the content delivery network 104.

The content delivery network 104 may comprise one or more origin servers 106 that are operative to maintain authoritative copies of resources for propagation and replication throughout the content delivery network 104. A content provider 102 transmits authoritative copies of given resources to an origin server 106. A given origin server 106 receives a request for a resource that is not available to a given edge server 108, 110, 112 and 114. The origin server is operative to recognize that the resource “ira?file1.js&file2.js&file3.js” is a request for a concatenated resource that comprises one or more source resources. According to the present embodiment, a request for a resource of the form “ira?” indicates a call to a resource aggregator 130 that the origin server 106 maintains.

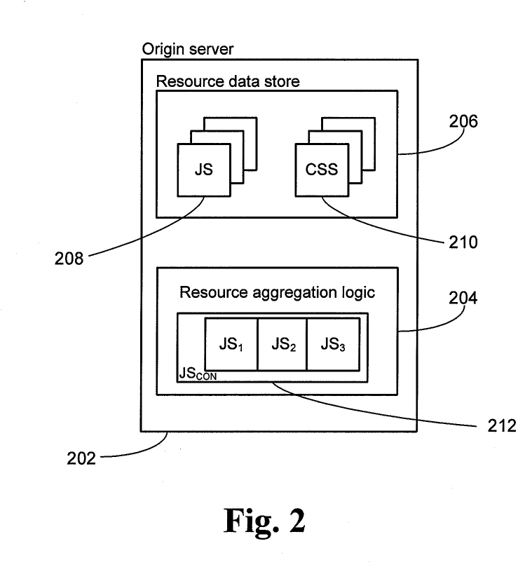

FIG. 2 presents a more detailed illustration of an origin server in accordance with one embodiment of the present invention. According to the embodiment of FIG. 2, the origin server 202 comprises resource aggregation logic 204 and a resource data store 206. The resource data store 206 may comprise one or more types of data stores known to those of skill in the art including, but not limited to, a flat file data store (tab or comma separated value file), a relational database, an object oriented database, a hybrid relational-object database, etc. The resource data store 206 is operative to receive and maintain resources from a content provider 102. Resources that the resource data store 206 may maintain include, but are not limited to, a plurality of JavaScript files 208 and a plurality of Cascading Style Sheets 210.

The resource aggregation logic 204 is operative to concatenate a plurality of resources 208 and 210 from the resource data store 206 to generate a concatenated resource 212. The resource aggregation logic 204 receives a request for a concatenated resource, which the origin server 202 may receive from one or more edge servers in the content delivery network or one or more clients in communication with the content delivery network. The resource aggregation logic 204 parses the request that it receives to identify the resources from the resource data store 206 that the request identifies for concatenation, concatenating the identified resources into a concatenated resource. For example, assume that the resource aggregation logic receives a request for a resource comprising three JavaScript files: JS₁, JS₂ and JS₃. The resource aggregation logic parses the request to identify the resources and retrieves the resources JS₁, JS₂ and JS₃, concatenating the resources into the resultant file JS_{CON} 212.

In addition to the foregoing functionality, the resource aggregation logic 204 may comprise additional functionality beyond concatenation or aggregation of resources. According to embodiments of the invention, the resource aggregation logic 204 may implement one or more of the following additional functionalities: compression, minification, dependency order maintenance and support for subdirectories. Where the resource aggregation logic 204 implements minification, the resource aggregation logic 204 is operative to parse or otherwise traverse a concatenated resource to remove unnecessary whitespace, thereby achieving additional compression of the concatenated resource. The resource aggregation logic 204 may further maintain the dependency order of resources for concatenation to ensure the concatenation of resources in the proper order. Finally, the resource aggregation logic 204 may support locating resources within a directory hierarchy, which according to one embodiment may be accomplished by the specification of a relative path in conjunction with the filename that the client requests.

Retuning to FIG. 1, the resource aggregator 130 builds the concatenated resource at the origin server 106 in response to a client 124 and 126 issuing a request for the concatenated resource. The origin server 106 transmits the concatenated resource to the client 124 and 126 initiating the request for the concatenated resource. According to one embodiment, the origin server 106 transmits the concatenated resource to the client device 124 and 126. Alternatively, the origin server 106 transmits the concatenated resource to an edge server 108, 110, 112 and 114 from which the origin server receives the request for the concatenated resource, with the edge server 108, 110, 112 and 114 transmitting the concatenated resource to the client device 124 and 126. The origin server 106 may also propagate the concatenated resource to other edge servers in the content delivery network 104, a given edge server 108, 110, 112 and 114 maintaining a copy of the concatenated resource in the cache 116, 118, 120 and 122, respectively, to serve in response to a subsequent client request for the concatenated resource.

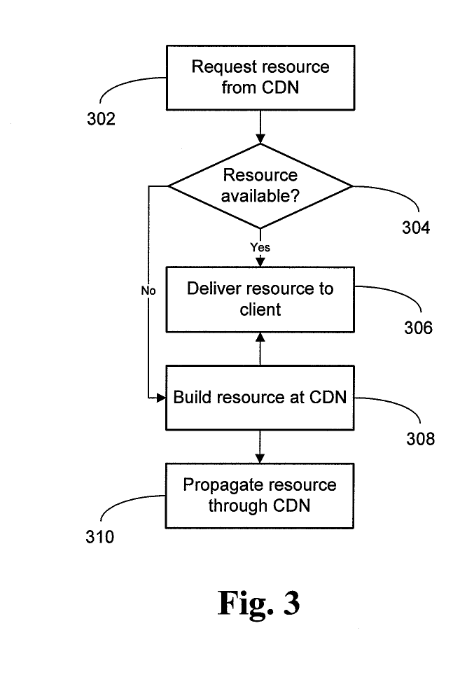

FIG. 3 presents a flow diagram illustrating as high level method of operating a system for resource aggregation according to one embodiment of the present invention. According to the embodiment of FIG. 3, a client device requests a concatenated resource from a content delivery network, the request identifying a plurality of resources that the concatenated resource comprises, step 302. For example, when a client receives a content item, such as a web page, the content item may comprise a link or reference to a concatenated resource that the content delivery network hosts, causing the client to issue a request to the content delivery network to obtain the resource.

The content delivery network receives the request for the concatenated resource from the client and performs a check to determine if a copy of the concatenated resource is available in a resource data store, step 304. If a copy of the concatenated resource is available at the content delivery network, step 304, the content delivery network delivers the concatenated resource to the client, step 306. Where the concatenated resource is not available to the content delivery network, step 304, the content delivery network builds the concatenated resource from the resources that the client identifies in its request, step 308. The built concatenated resource is transmitted to the requesting client, step 306, and a copy of the concatenated resource may be propagated through the content delivery network, step 310, such that resource is available in response to a subsequent request from a client, step 304.

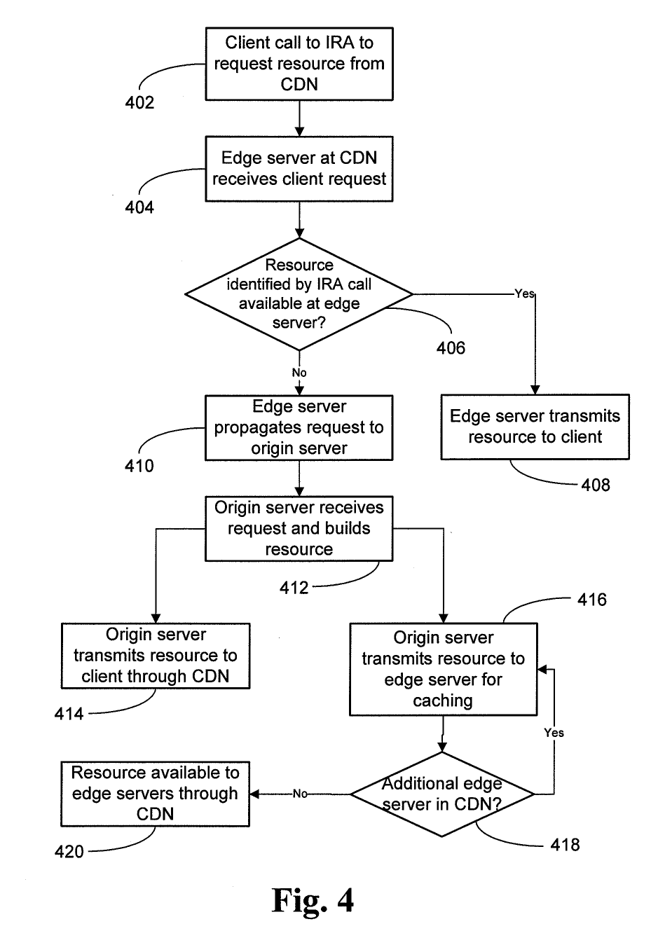

An alternative embodiment of a method of operating a system for resource aggregation is illustrated by FIG. 4. The process of FIG. 4 begins with a client call to a resource aggregator to request a concatenated resource from a content delivery network, step 402. At the content delivery network, an edge server receives the request from the client device, step 404. Requests for resources are intelligently routed to an edge server in an optimal manner. For example, when optimizing for performance, the content delivery network may select an edge server that is operative to serve content quickly to the client, which may be measured, for example, by choosing an edge server that is the fewest hops or fewest number of network seconds away from the client. When optimizing for cost, the content delivery network may select an edge server from which it is less expensive to serve data to the client.

The edge server that receives the request from the client (step 404) performs a check to determine if the resource that the call to the resource aggregator is requesting is available at the edge server, step 406, e.g., in a cache at the edge server. Where the resource is available at the edge server, the edge server transmits the resource to the requesting client, step 408. Where the resource is not available at the edge server, however, the edge server propagates the request through the content delivery network to a given origin server from among one or more origin servers available in the content delivery network, step 410.

The origin server receives the request for the resource and a resource aggregator operating at the origin server is operative to build the resource that the client is requesting, step 412. For example, where the call to the resource aggregator from the client identifies three CSS files for concatenation, the resource aggregator is operative to obtain copies of the three CSS files and concatenate the CSS files into a concatenated resource. The origin server builds the concatenated resource that the client requests, step 412, and the origin server transmits the concatenated resource to client through the content delivery network, step 414, which may comprise the origin server transmitting the concatenated resource to the edge server for subsequent transmission to the requesting client.

The origin server also transmits a copy of the concatenated resources to the edge server from which the origin server receives the request for the edge server to cache the concatenated resource, step 416. The origin server performs a check to determine if there are additional edge servers in the content delivery network at which the origin server may cache the concatenated resource, step 418. Where the check evaluates to true, the origin server may propagate the concatenated resources to another edge server in the content delivery network, step 416, such that the origin server caches a copy of the concatenated resource at the edge servers in the content delivery network and thereby ensuring that the concatenated resource is available to edge servers throughout the content delivery network, step 420. It should be noted by those of skill in the art that the origin server may perform propagation of a concatenated resource to edge servers in the CDN in parallel.

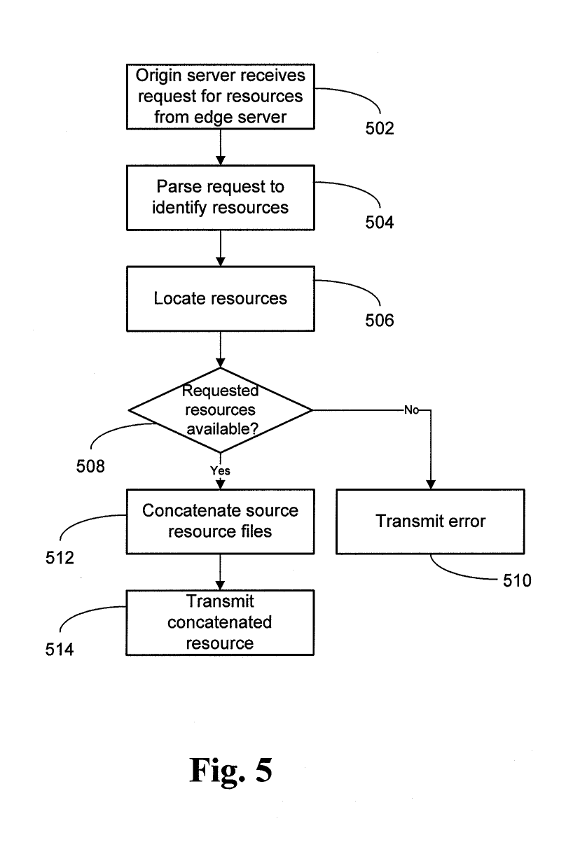

As discussed above, an origin server is operative to execute a resource aggregator, which the origin server or another server within or outside the content delivery network may maintain. FIG. 5 presents a flow diagram illustrating a method for resource aggregation according to one embodiment of the present invention. Resource aggregation in accordance with the present exemplary embodiment comprises the origin server receiving a request for a plurality of resources from an edge server in the content delivery network to which the origin server and the edge server belong, step 502.

The request is parsed to identify resources that comprise the request, step 504. According to one embodiment, the resource aggregator parses the request by traversing the request to identify resource delimiters that indicate a break between resources in a given request. For example, where a request comprises the elements “file1.js&file2.js” (which may be maintained on disparate physical or logical volumes), the resource aggregator may utilize the ampersand character to identify distinct resources in the request. Those of skill in the art recognize that the request may utilize other delimiters. An attempt is made to locate the resources that the request identifies, step 506, which may comprise the origin server or resource aggregator accessing resources on a local or remote data store.

A check is performed to determine if the resources that the request identifies are available, step 508. Where the check evaluates to false, the origin server may transmit an error response to the edge server from which the origin server receives the request, step 510, indicating that the concatenated resource is unavailable. Alternatively, the origin server may return a concatenated resource that comprises the available resources. Where the check evaluates to true, step 508, the resources that the request identifies are concatenated to generate a concatenated resource, step 512. According to one embodiment, the resources are text files comprising program or scripting code, the resource aggregator may use text processing tools known to those of skill in the art to concatenate the disparate resource files. The concatenated resource may be transmitted to the content delivery network, step 514.

FIGS. 1 through 5 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

1. A method for the aggregation and distribution of resources, the method comprising:
receiving a request from a client by a content delivery network (“CDN”) for a resource that comprises a plurality of resources;
concatenating the plurality resources at the content delivery network to generate a concatenated resource.
propagating the concatenated resource to the client through the content delivery network.

2. The method of claim 1, wherein receiving the request comprises receiving a request for a plurality of JavaScript files.

3. The method of claim 1, wherein receiving the request comprises receiving a request for a plurality of Cascading Style Sheet files.

4. The method of claim 1, wherein receiving the request comprises receiving the request by an edge server in the content delivery network.

5. The method of claim 4, comprising checking for a cached copy of the concatenated resource at the edge server.

6. The method of claim 5, comprising propagating the cached copy of the concatenated resource from the edge server to the client.

7. The method of claim 5, comprising transmitting the request for the resource from the edge server to an origin server if the cached copy of the concatenated resource is not available at the edge server.

8. The method of claim 7, comprising receiving the request at the origin server for concatenation of the plurality resources.

9. The method of claim 1, wherein propagating comprises transmitting the concatenated resource from an origin server in the CDN to the requesting client.

10. The method of claim 1, wherein propagating comprises transmitting the concatenated resource from an origin server to an edge server from which the origin server receives the request.

11. The method of claim 10, comprising transmitting the concatenated resource from the edge server to the client.

12. The method of claim 10, comprising caching the concatenated resource at the edge server.

13. The method of claim 12, wherein caching the concatenated resource at the edge server comprises caching the concatenated resource at one or more other edge servers in the CDN.

14. Computer readable media comprising program code that when executed by a programmable processor instructs the processor to execute a method for the aggregation and distribution of resources, the computer readable media comprising:
program code for receiving a request from a client by a content delivery network (“CDN”) for a resource that comprises a plurality of resources;
program code for concatenating the plurality resources at the content delivery network to generate a concatenated resource.
program code for propagating the concatenated resource to the client through the content delivery network.

15. The method of claim 14, wherein the program code for receiving the request comprises program code for receiving a request for a plurality of JavaScript files.

16. The method of claim 14, wherein the program code for receiving the request comprises program code for receiving a request for a plurality of Cascading Style Sheet files.

17. The computer readable media of claim 14, wherein the program code for receiving the request comprises program code for receiving the request by an edge server in the content delivery network.

18. The computer readable media of claim 17, comprising program code for checking for a cached copy of the concatenated resource at the edge server.

19. The computer readable media of claim 18, comprising program code for propagating the cached copy of the concatenated resource from the edge server to the client.

20. The computer readable media of claim 18, comprising program code for transmitting the request for the resource from the edge server to an origin server if the cached copy of the concatenated resource is not available at the edge server.

21. The computer readable media of claim 20, comprising program code for receiving the request at the origin server for concatenation of the plurality resources.

22. The computer readable media of claim 14, wherein the program code for propagating comprises program code for transmitting the concatenated resource from an origin server in the CDN to the requesting client.

23. The computer readable media of claim 14, wherein the program code for propagating comprises program code for transmitting the concatenated resource from an origin server to an edge server from which the origin server receives the request.

24. The computer readable media of claim 23, comprising program code for transmitting the concatenated resource from the edge server to the client.

25. The computer readable media of claim 23, comprising program code for caching the concatenated resource at the edge server.

26. (canceled)
